(19) United States
(12) Patent Application Publication
(10) Pub. No.: US 2019/0131635 A1
(43) Pub. Date: May 2, 2019

(54) Cell Frame for Fuel Cell and Fuel Cell Stack Using the Same

(71) Applicants: Hyundai Motor Company, Seoul (KR); Kia Motors Corporation, Seoul (KR)

(72) Inventors: Seong Il Heo, Yongin-si (KR); Byeong-Heon Jeong, Yongin-si (KR)

(21) Appl. No.: 16/020,522

(22) Filed: Jun. 27, 2018

(30) Foreign Application Priority Data
Oct. 30, 2017 (KR) 10-2017-0142112

(51) Int. Cl. H01M 8/0267; H01M 8/2465; H01M 8/0258; H01M 8/1004; H01M 8/0247

(52) U.S. Cl. CPC H01M 8/0267; H01M 8/2465; H01M 2008/1095; H01M 8/1004; H01M 8/0247; H01M 8/0258

(57) ABSTRACT

A fuel cell stack includes a number of cell frames, each including a reaction cell and a frame extending from an outer circumferential surface of the reaction cell. The frame is provided with a gasket insertion groove extending continuously along flow lines of air, hydrogen gas, and cooling water to form a closed curve. The fuel cell stack also includes a number of separator units, each inserted between a pair of cell frames and including a cathode separator and an anode separator that are integrally stacked together, such that the air, the hydrogen gas, and the cooling water are allowed to flow independently. A gasket is inserted into the gasket insertion groove to provide airtightness between each of the cell frames and an associated separator unit.

### CROSS-REFERENCE TO RELATED APPLICATIONS

This application claims priority to Korean Patent Application No. 10-2017-0142112, filed on Oct. 30, 2017, which application is hereby incorporated herein by reference.

### TECHNICAL FIELD

The present invention relates to a cell frame and a fuel cell stack using the same.

### BACKGROUND

In general, a fuel cell, which is a type of power generation device that converts chemical energy of a fuel into electric energy through electrochemical reaction in a stack, produces electric power for small electronic devices such as portable devices as well as produces driving power for industrial use, household use, and vehicles. In recent years, the use of the fuel cell has been gradually increasing as a highly efficient and clean energy source.

In particular, a polymer electrolyte membrane fuel cell (PEMFC) having advantages such as a relatively low operating temperature, a fast operation, and a fast response characteristic is mainly used for supplying driving power of a vehicle.

A PEMFC stack is manufactured by stacking a plurality of unit cells each including a membrane electrode assembly (MEA) composed of an anode, a cathode, and a polymer electrolyte membrane therebetween, gas diffusion layers (GDLs), metal separators called bipolar plates, and gaskets.

The membrane electrode assembly is formed by attaching electrodes to an electrolyte membrane. The electrolyte membrane is typically made from an ion conducting polymer, which is required to have high ionic conductivity, high mechanical strength under humidification conditions, low gas permeability, and high thermal/chemical stability.

Further, the gas diffusion layers serve to finely diffuse hydrogen and air introduced from the channels of the separators to supply them to the membrane electrode assembly, to support catalyst layers, and to move electrons generated in the catalyst layers to the separators, the gas diffusion layers being stacked on upper and lower surfaces of the membrane electrode assembly and serving as a passage allowing generated water to be discharged therethrough from the catalyst layers.

Recently, in order to improve manufacturing convenience of the fuel cell stack, a cell frame for a fuel cell, in which the membrane electrode assembly and the gas diffusion layers are integrated with each other, has been developed.

Such a cell frame can facilitate stacking of the fuel cells composing the fuel cell stack and thus can improve quality of stacking of the fuel cells. In addition, the cell frame can improve performance and durability of the fuel cell and reduce occurrence of defects. However, the cell frame is problematic in that the thickness of the fuel cell stack is increased compared to a conventional fuel cell stack, leading to an increase in volume.

Accordingly, there is a need to develop a technique capable of maintaining airtightness the fuel cell stack manufactured using the integral-type cell frame while reducing the thickness thereof.

The foregoing is intended merely to aid in the understanding of the background of the present invention, and is not intended to mean that the present invention falls within the purview of the related art that is already known to those skilled in the art.

### SUMMARY

The present invention relates generally to a cell frame and a fuel cell stack using the same, the cell frame being configured such that a membrane electrode assembly and gas diffusion layers are provided integrally with each other. In particular embodiments, the present invention relates to a cell frame for a fuel cell and a fuel stack using the same, wherein thickness and differential pressure of the fuel cell stack can be reduced, and discharge of condensed water can be facilitated.

The present invention has been made keeping in mind the above problems occurring in the related art, and embodiments of the present invention provide a cell frame for a fuel cell and a fuel cell stack using the same, wherein the cell frame is configured such that the MEA and the GDL are integrated with each other and a coupling structure with a separator is improved, thereby reducing the thickness of the cell frame and reducing the volume of the fuel cell.

Further embodiments of the present invention provide a cell frame for a fuel cell and a fuel cell stack using the same, wherein the cell frame is configured to improve a flow structure of reactant gas and cooling water, thereby reducing differential pressure and efficiently discharging condensed water generated and thus improving the durability and stability of the fuel cell.

Technical advantages to be achieved in the present invention are not limited to the aforementioned technical objects, and other non-mentioned technical advantages will be understood by those skilled in the art from the description below.

According to one aspect of the present invention, a fuel cell stack includes a plurality of cell frames each including a reaction cell and a frame extending from an outer circumferential surface of the reaction cell. The frame is provided with a gasket insertion groove formed by extending continuously along flow lines of air, hydrogen gas, and cooling water to form a closed curve. A plurality of separator units are each inserted between a pair of cell frames and include a cathode separator and an anode separator that are integrally stacked together, such that the air, the hydrogen gas, and the cooling water are allowed to flow independently. A gasket is inserted into the gasket insertion groove to provide airtightness between each of the cell frames and an associated separator unit, and is configured such that when the gasket is compressed, a first surface thereof is positioned on a same line as a first surface of the frame.

The frame may be provided with a reinforcement portion surrounding an edge of the reaction cell.

The reinforcement portion may be formed at a portion where the air and the hydrogen gas do not flow.

Air flow channels may be defined on a first surface of the cathode separator, hydrogen gas flow channels may be defined on a second surface of the anode separator, and cooling water flow channels may be defined between the cathode separator and the anode separator. The frame may be provided with a plurality of air inlets formed on a surface of the frame which is in contact with the cathode separator, the air inlets allowing an air manifold and the air flow channels to communicate with each other. A plurality of hydrogen gas inlets are formed on a surface of the frame which is in contact with the anode separator. The hydrogen gas inlets allow a hydrogen gas manifold and the hydrogen gas flow channels to communicate with each other. The air inlets and the hydrogen gas inlets are arranged on a same line as the air flow channels and the hydrogen gas flow channels, respectively.

The frame may be provided with a plurality of cooling water inlets formed on the surface of the frame which is in contact with the anode separator, the cooling water inlets allowing a cooling water manifold and the cooling water flow channels, and the anode separator is provided with a plurality of bent portions corresponding to the respective cooling water inlets such that the cooling water is allowed to flow toward a first surface of the anode separator.

The separator unit may be provided with a plurality of guide portions guiding the cooling water flowing in through the respective cooling water inlets to flow toward the cooling water flow channels.

According to another aspect of the present invention, a cell frame for a fuel cell includes a reaction cell including a membrane electrode assembly (MEA) and a gas diffusion layer (GDL) provided on each of opposite surfaces of the MEA. A frame extends from an outer circumferential surface of the reaction cell, and is provided with a gasket insertion groove formed on a surface of the frame by extending continuously along flow lines of air, hydrogen gas, and cooling water to form a closed curve, such that a gasket is inserted into the gasket insertion groove.

The frame may be provided with a reinforcement portion surrounding an edge of the reaction cell.

The reinforcement portion may be formed at a portion where the air and the hydrogen gas do not flow.

The frame may be provided with a plurality of air inlets, a plurality of cooling water inlets, and a plurality of hydrogen gas inlets that are sequentially arranged to be grouped together on opposite sides of the frame in a width direction thereof, wherein the air inlets and the hydrogen gas inlets communicate with first and second surfaces of the reaction cell, respectively.

According to the embodiment of the present invention, the structure of the cell frame is improved so that hydrogen gas and air are allowed to flow rectilinearly toward the first and second surfaces of the reaction cell without deviation, thereby reducing differential pressure and thus improving the durability and stability of the fuel cell manufactured.

In addition, the gasket insertion groove is formed on the surface of the cell frame, so that the thickness of the fuel cell stack can be reduced by the thickness of the gasket when assembling the fuel cell stack, thereby reducing the volume of the fuel cell and improving the performance of the fuel cell.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a cell frame according to an embodiment of the present invention;

FIG. 2 is a partial cutaway view taken along line A-A′ of FIG. 1, which shows a reinforcement portion according to the embodiment of the present invention;

FIG. 3 is an exploded perspective view showing a fuel cell stack according to an embodiment of the present invention;

FIG. 4 is a partial perspective view showing a separator unit according to the embodiment of the present invention;

FIG. 5 is a cross-sectional view taken along line B-B′ of FIG. 3, which shows air inlets and air flow channels according to the embodiment of the present invention;

FIG. 6 is a cross-sectional view taken along line D-D′ of FIG. 3, which shows hydrogen gas inlets and hydrogen gas flow channels according to the embodiment of the present invention; and

FIG. 7 is a cross-sectional view taken along line C-C′ of FIG. 3, which shows cooling water inlets and cooling water flow channels according to the embodiment of the present invention.

### DETAILED DESCRIPTION OF ILLUSTRATIVE EMBODIMENTS

Hereinbelow, exemplary embodiments of the present invention will be described in detail with reference to the accompanying drawings. Various changes to the following embodiments are possible and the scope of the present invention is not limited to the following embodiments. Throughout the drawings, the same reference numerals will refer to the same or like parts and can be described by referring to the contents described in other drawings in the following description, and the contents that are determined to be apparent to those skilled in the art or that are repeated may be omitted.

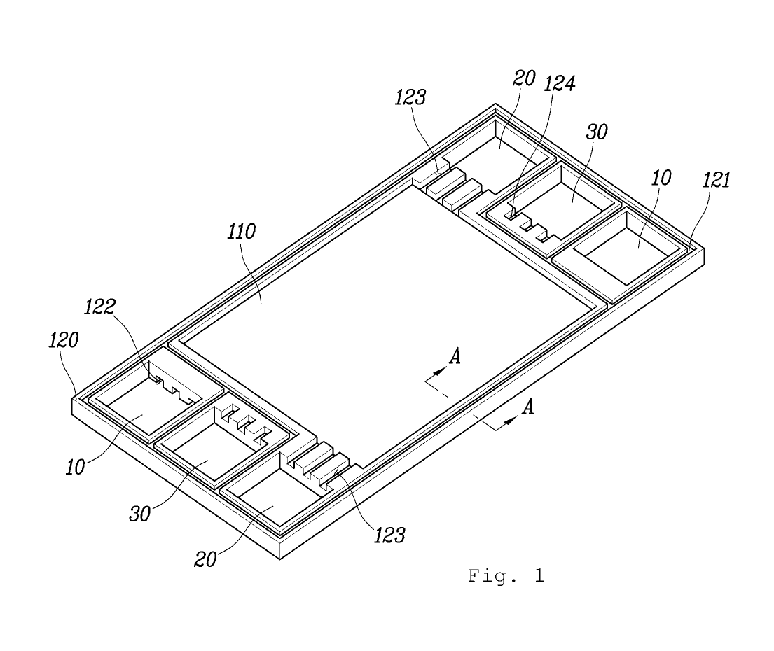

FIG. 1 is a perspective view showing a cell frame according to an embodiment of the present invention.

As shown in FIG. 1, the cell frame 100 according to the embodiment of the present invention includes a reaction cell no for producing electrical energy through an oxidation-reduction reaction, and a frame 120 extending from an outer circumferential surface of the reaction cell no.

The reaction cell no includes a membrane electrode assembly (MEA) composed of an electrolyte membrane, a cathode electrode, and an anode electrode that are provided integrally with each other; and a gas diffusion layer (GDL) provided on each of opposite surfaces of the MEA and allowing hydrogen gas and air to diffuse therethrough, wherein the reaction cell no allows the hydrogen gas and the air that flow into the MEA through the GDL to undergo oxidation (a loss of electrons) and reduction (a gain of electrons) reactions, respectively, thereby producing electrical energy.

Herein, the frame 120 is integrally formed by extending from the outer circumferential surface of the reaction cell no by injection. The frame 120 is provided with a gasket insertion groove 121 formed on each of first and second surfaces of the frame 120 by extending continuously along flow lines of cooling water and reactant gas which is composed of air and hydrogen gas, thereby forming a closed curve. Here, it is noted that the first and second surfaces of the frame 120 mean the upper and lower surfaces of the frame shown in FIG. 1.

Accordingly, when manufacturing a fuel cell stack by stacking a plurality of cell frames 100 according to the embodiment of the present invention, a plurality of gaskets, and a plurality of separators, each gasket is inserted into the gasket insertion groove 121 whereby the thickness of the fuel cell stack can be reduced by the thickness of the gasket inserted. Further, the performance of the fuel cell, such as output and the like can be improved with respect to the same volume.

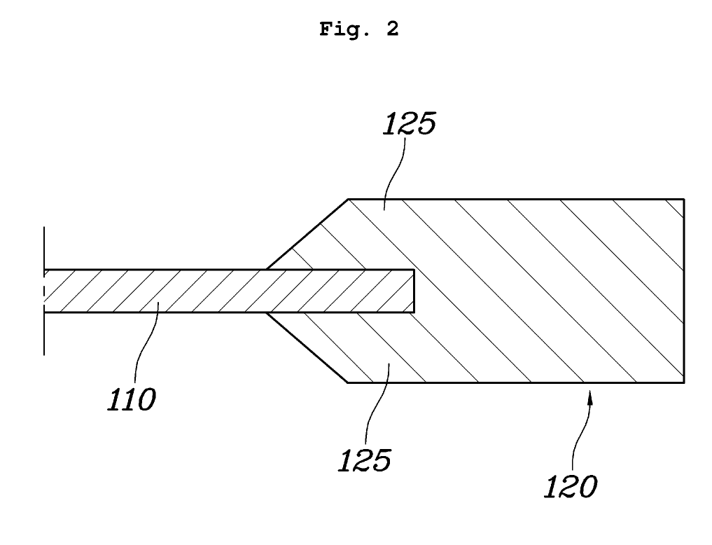

FIG. 2 is a partial cutaway view taken along line A-A′ of FIG. 1, which shows a reinforcement portion according to the embodiment of the present invention.

As shown in FIG. 2, the frame 120 according to the embodiment of the present invention may be provided with the reinforcement portion 125 surrounding an edge of the reaction cell no.

Accordingly, a coupling force between the reaction cell 110 and the cell frame 100 can be improved as compared with a conventional cell frame integrally formed by extending from the outer circumferential surface of the reaction cell 110, leading to an increase in durability of the cell frame 100 manufactured. In addition, damage and breakage that occur during stacking of the fuel cell stack can be minimized, leading to a reduction in defects of the fuel cell manufactured and an increase in lifetime thereof.

The reinforcement portion 125 according to the embodiment of the present invention may be formed at a portion where reactant gas does not flow.

Herein, the frame 120 is provided with a plurality of air inlets 122, a plurality of cooling water inlets 124, and a plurality of hydrogen gas inlets 123 that are sequentially arranged to be grouped together on opposite sides of the frame 120 in the width direction thereof. The air inlets 122 and the hydrogen gas inlets 123 may communicate with the first and second surfaces of the reaction cell no, respectively.

Due to the above structure, reactant gas can flow rectilinearly in the fuel cell stack employing the cell frame 100 according to the embodiment of the present invention, thereby reducing differential pressure in the fuel cell stack. In addition, the reactant gas and the reaction cell no can be brought into contact with each other more quickly, thereby improving performance and efficiency of the fuel cell.

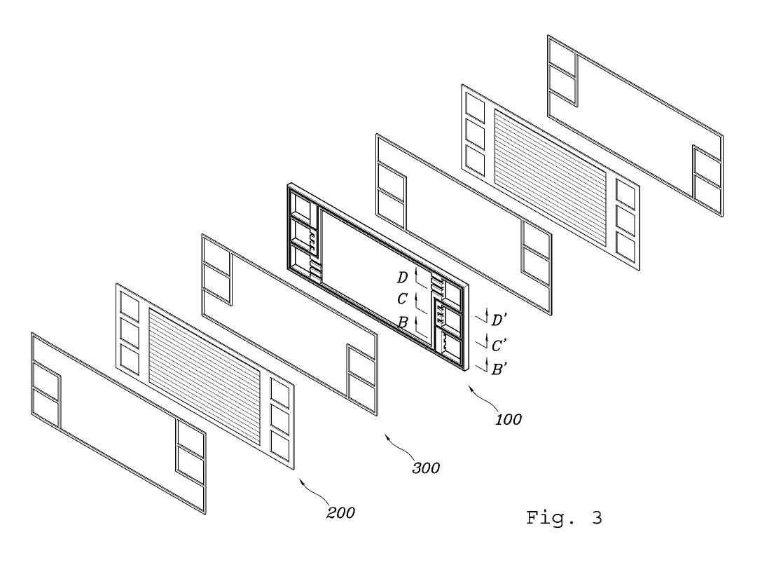

FIG. 3 is an exploded perspective view showing the fuel cell stack according to an embodiment of the present invention.

As shown in FIG. 3, the fuel cell stack according to the embodiment of the present invention is formed by stacking a plurality of cell frames 100 each including a reaction cell no and a frame 120 surrounding the reaction cell 110, a plurality of separator units 200, and a plurality of gaskets 300.

The cell frames 100 according to the embodiment of the present invention are provided in the same manner as described above.

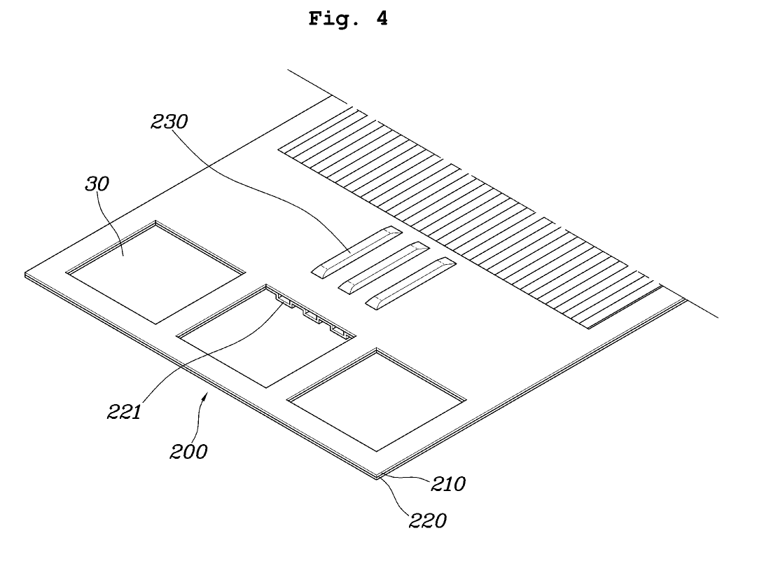

FIG. 4 is a partial perspective view showing the separator unit according to the embodiment of the present invention.

As shown in FIG. 4, each of the separator units 200 according to the embodiment of the present invention includes a cathode separator 210 and an anode separator 220 that are stacked together, the separator unit being positioned between a pair of cell frames 100.

According to the embodiment of the present invention, air flow channels 201 through which air flows are defined on a first surface of the cathode separator 210, hydrogen gas flow channels 202 through which hydrogen gas flows are defined on a second surface of the anode separator 220, and cooling water flow channels 203 through which cooling water flows are defined between the cathode separator 210 and the anode separator 220.

Herein, the frame 120 according to the embodiment of the present invention may be configured such that a plurality of air inlets 122 allowing an air manifold 10 and the air flow channels 201 to communicate with each other is formed on a surface of the frame 120 which is in contact with the cathode separator 210 by extending in the lengthwise direction of the frame 120, and a plurality of hydrogen gas inlets 123 allowing a hydrogen gas manifold 20 and the hydrogen gas flow channels 202 to communicate with each other is formed on a surface of the frame 120 which is in contact with the anode separator 220 by extending in the lengthwise direction of the frame 120, wherein the respective air inlets 122 are arranged on the same line as the air flow channels 201, and the respective hydrogen gas inlets 123 are arranged on the same line as the hydrogen gas flow channels 202.

Thus, the fuel cell stack is configured such that air supplied from the air manifold 10 is allowed to flow rectilinearly to the air flow channels 201 through the air inlets 122, and hydrogen gas supplied from the hydrogen gas manifold 20 is allowed to flow rectilinearly to the hydrogen gas flow channels 202 through the hydrogen gas inlets 123, whereby there is an effect that differential pressure in the fuel cell stack manufactured can be reduced.

Further, the frame 120 according to the embodiment of the present invention may be provided with a plurality of cooling water inlets 124 formed on the surface of the frame 120 which is in contact with the anode separator 220. The cooling water inlets 124 allow a cooling water manifold 30 and the cooling water flow channels 203 to communicate with each other.

Herein, the anode separator 220 may be provided with a plurality of bent portions 221 bent corresponding to the respective cooling water inlets 124 such that cooling water can flow toward a first surface of the anode separator 220.

Thus, cooling water supplied from the cooling water manifold 30 is allowed to flow toward the cooling water flow channels 203 defined between the anode separator 220 and the cathode separator 210 through the cooling water inlets 124 via the bent portions 221 of the anode separator 220.

The separator unit 200 according to the embodiment of the present invention may be provided with a plurality of guide portions 230 bent to allow cooling water flowing in through the cooling water inlets 124 to flow toward the cooling water flow channels 203 defined between the cathode separator 210 and the anode separator 220 by passing over the gasket 300.

Thus, reactant gas can flow rectilinearly toward the reaction cell no and at the same time, cooling water flowing in through the cooling water inlets 124 can be guided to flow toward the cooling water flow channels 203 by passing over the gasket 300.

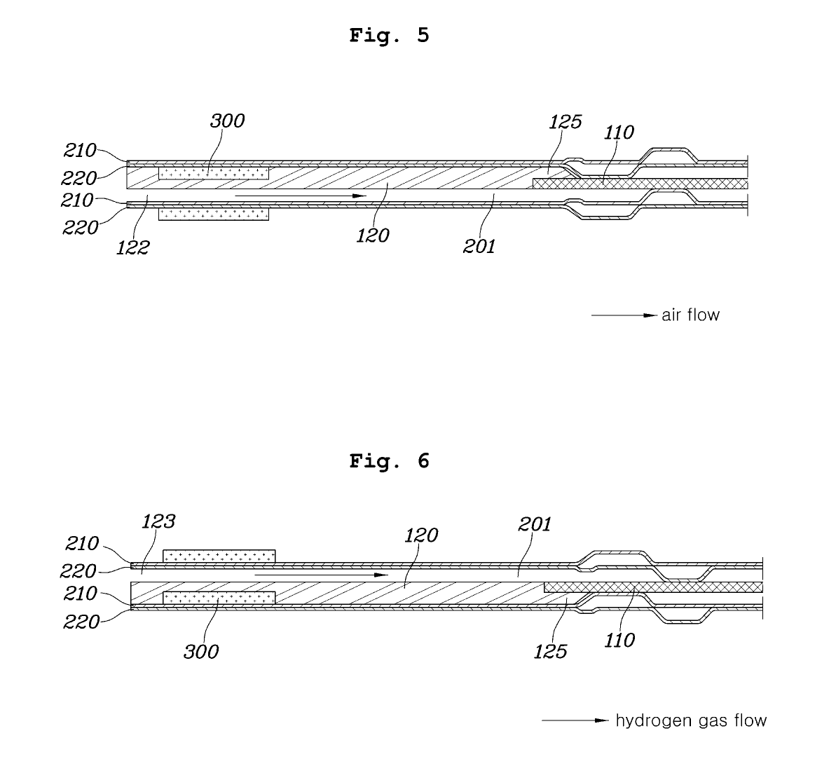

FIG. 5 is a cross-sectional view taken along line B-B′ of FIG. 3, which shows the air inlets and the air flow channels according to the embodiment of the present invention, and FIG. 6 is a cross-sectional view taken along line D-D′ of FIG. 3, which shows the hydrogen gas inlets and the hydrogen gas flow channels according to the embodiment of the present invention.

As shown in FIG. 5, when the separator units 200 each composed of the cathode separator 210 and the anode separator 220 that are stacked together, and the cell frame 100 are stacked on top of each other such that the cell frame 100 is positioned between the separator units 200, hydrogen gas and air that flow in from the hydrogen gas manifold 20 and the air manifold 10 flow rectilinearly toward the hydrogen gas flow channels 202 and the air flow channels 201 through the hydrogen gas inlets 123 and the air inlets 122 that are formed on the opposite sides of the frame 120, respectively.

Thus, since bent portions are absent on the flow lines of hydrogen gas and air, differential pressure can be reduced when the hydrogen gas and the air flow. Consequently, durability and lifetime of the fuel cell stack manufactured can be increased, and stability and performance of the fuel cell can be further improved.

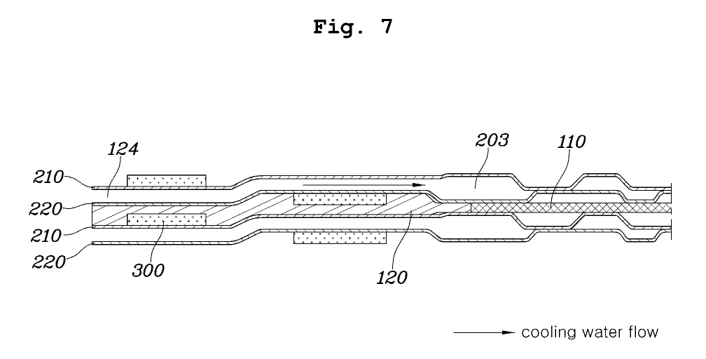

FIG. 7 is a cross-sectional view taken along line C-C′ of FIG. 3, which shows the cooling water inlets and the cooling water flow channels according to the embodiment of the present invention.

As shown in FIG. 7, according to the embodiment of the present invention, cooling water, which is supplied from the cooling water manifold 30 and flows in through the cooling water inlets 124, is guided by the guide portions 230 to pass over the gasket 300 inserted into each of the first and second surfaces of the frame 120 and then flows toward the cooling water flow channels 203.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A fuel cell stack, comprising:
a plurality of cell frames, each cell frame including a reaction cell and a frame extending from an outer circumferential surface of the reaction cell, the frame being provided with a gasket insertion groove extending continuously along flow lines of air, hydrogen gas, and cooling water to form a closed curve;
a plurality of separator units, each separator unit inserted between a pair of cell frames and including a cathode separator and an anode separator that are integrally stacked together, such that the air, the hydrogen gas, and the cooling water are allowed to flow independently; and
a gasket inserted into the gasket insertion groove to provide airtightness between each of the cell frames and an associated separator unit, the gasket configured such that when the gasket is compressed, a first surface thereof is positioned on a same line as a first surface of the frame.

2. The fuel cell stack of claim 1, wherein the frame is provided with a reinforcement portion surrounding an edge of the reaction cell.

3. The fuel cell stack of claim 2, wherein the reinforcement portion is formed at a portion where the air and the hydrogen gas do not flow.

4. The fuel cell stack of claim 1, wherein air flow channels are defined on a first surface of the cathode separator, hydrogen gas flow channels are defined on a second surface of the anode separator, and cooling water flow channels are defined between the cathode separator and the anode separator.

5. The fuel cell stack of claim 4, wherein the frame is provided with:
a plurality of air inlets formed on a surface of the frame that is in contact with the cathode separator, the air inlets allowing an air manifold and the air flow channels to communicate with each other; and
a plurality of hydrogen gas inlets formed on a surface of the frame that is in contact with the anode separator, the hydrogen gas inlets allowing a hydrogen gas manifold and the hydrogen gas flow channels to communicate with each other.

6. The fuel cell stack of claim 5, wherein the air inlets and the hydrogen gas inlets are arranged on a same line as the air flow channels and the hydrogen gas flow channels, respectively.

7. The fuel cell stack of claim 6, wherein the frame is provided with a plurality of cooling water inlets formed on the surface of the frame that is in contact with the anode separator, the cooling water inlets allowing a cooling water manifold and the cooling water flow channels.

8. The fuel cell stack of claim 7, wherein the anode separator is provided with a plurality of bent portions corresponding to respective cooling water inlets such that the cooling water is allowed to flow toward a first surface of the anode separator.

9. The fuel cell stack of claim 8, wherein each separator unit is provided with a plurality of guide portions guiding the cooling water flowing in through the corresponding cooling water inlets to flow toward the cooling water flow channels.

10. A cell frame for a fuel cell, the cell frame comprising:
a reaction cell including a membrane electrode assembly (MEA) and a gas diffusion layer (GDL) provided on each of opposite surfaces of the MEA; and
a frame extending from an outer circumferential surface of the reaction cell, the frame provided with a gasket insertion groove formed on a surface of the frame by extending continuously along flow lines of air, hydrogen gas, and cooling water to form a closed curve, such that a gasket can be inserted into the gasket insertion groove.

11. The cell frame of claim 10, wherein the frame is provided with a reinforcement portion surrounding an edge of the reaction cell.

12. The cell frame of claim 11, wherein the reinforcement portion is formed at a portion where the air and the hydrogen gas do not flow.

13. The cell frame of claim 10, further comprising a gasket inserted into the gasket insertion groove.

14. The cell frame of claim 10, wherein the frame is provided with a plurality of air inlets, a plurality of cooling water inlets, and a plurality of hydrogen gas inlets that are sequentially arranged to be grouped together on opposite sides of the frame in a width direction thereof, and wherein the air inlets and the hydrogen gas inlets communicate with first and second surfaces of the reaction cell, respectively.
